(19) United States
(12) Patent Application Publication
(10) Pub. No.: US 2024/0265609 A1
(43) Pub. Date: Aug. 8, 2024

(54) LOW BITRATE DIGITAL HUMAN COMMUNICATION SESSIONS USING MOTION CAPTURE DATA STREAMS

(71) Applicant: Charter Communications Operating, LLC, St. Louis, MO (US)

(72) Inventors: Dell Wolfensparger, Seaview, WA (US); Christopher Glen Turner, Aurora, CO (US); Matthew Robert Ringenberg, Englewood, CO (US)

(21) Appl. No.: 18/163,719

(22) Filed: Feb. 2, 2023

(51) Int. Cl. G06T 13/40; H04L 65/1069

(52) U.S. Cl. CPC G06T 13/40; H04L 65/1069

(57) ABSTRACT

A first computing device establishes a communication session with a second computing device. The first computing device receives a first motion capture data stream originating from the second computing device during the communication session, the first motion capture data stream quantifying real-time movements of a first user of the second computing device. The first computing device renders, to a display device, imagery of an animation of a three-dimensional (3D) model of the first user based on the first motion capture data stream that depicts the real-time movements of the first user.

### BACKGROUND

A video conference is often preferred to an audio-only conference because communications are often easier to understand when a listener can see the speaker due to verbal and non-verbal clues of the speaker. However, streaming imagery that depicts the participants, especially high-resolution imagery, requires relatively high-bandwidth network connections between the participants. The greater the number of participants, the greater the number of image streams that are generated and communicated over the network. Often the streaming of video imagery degrades the audio and video quality of the conference due to a finite amount of network bandwidth.

### SUMMARY

The embodiments implement low bitrate digital human communication sessions using motion capture data streams that provides resolution three-dimensional (3D) imagery of a participant of a visual and audible conference that depict hyper-realistic movements of the participant, including macro and micro facial expressions, without the need to stream imagery, thereby vastly reducing network bandwidth consumption and allowing audible and visual conferencing over low-bandwidth communication links.

In one embodiment a method is provided. The method includes establishing, by a first computing device with a second computing device, a communication session. The method further includes receiving, by the first computing device, a first motion capture data stream originating from the second computing device during the communication session, the first motion capture data stream quantifying real-time movements of a first user of the second computing device. The method further includes rendering, by the first computing device to a display device, imagery of an animation of a three-dimensional (3D) model of the first user based on the first motion capture data stream that depicts the real-time movements of the first user.

In another embodiment a computing device is provided. The computing device includes a memory, and a processor device coupled to the memory operable to establish, with a second computing device, a communication session. The processor device is further operable to receive a first motion capture data stream originating from the second computing device during the communication session, the first motion capture data stream quantifying real-time movements of a first user of the second computing device. The processor device is further operable to render, to a display device, imagery of an animation of a three-dimensional (3D) model of the first user based on the first motion capture data stream that depicts the real-time movements of the first user.

In another embodiment a non-transitory computer-readable storage medium is provided. The non-transitory computer-readable storage medium includes executable instructions operable to cause a processor device to establish, with a second computing device, a communication session. The executable instructions are further operable to receive a first motion capture data stream originating from the second computing device during the communication session, the first motion capture data stream quantifying real-time movements of a first user of the second computing device. The executable instructions are further operable to render, to a display device, imagery of an animation of a three-dimensional (3D) model of the first user based on the first motion capture data stream that depicts the real-time movements of the first user.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which low bitrate digital human communication sessions using motion capture data streams can be implemented according to some embodiments;

FIG. 2 is a flowchart of a method for implementing a low bitrate digital human communication session using motion capture data streams according to one embodiment;

FIG. 3 is a block diagram of an environment in which low bitrate digital human communication sessions using motion capture data streams can be implemented according to another embodiment;

FIG. 4 is a block diagram of an environment in which low bitrate digital human communication sessions using motion capture data streams can be implemented according to another embodiment; and

FIG. 5 is a block diagram of a computing device suitable for implementing embodiments disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Video conferencing is often preferred to an audio-only conference because communications are often easier to understand when a listener can see the speaker due to verbal and non-verbal clues of the speaker. However, streaming imagery that depicts the participants, especially high-resolution imagery, requires relatively high-bandwidth network connections between the participants. The greater the number of participants, the greater the number of image streams that are generated and communicated over the network. Often the streaming of video imagery degrades the audio and video quality of the conference due to a finite amount of network bandwidth.

Many computing devices used for video conferences include or can be communicatively coupled to one or more sensors that are capable of gathering and quantifying information about the scene within a field of view of the sensors. For example, smart phones increasingly include motion and depth sensors capable of mathematically measuring human features in three-dimensional (3D) space. Such sensors may comprise, for example, time of flight sensors, or a depth camera, such as, by way of non-limiting example, an Apple® TrueDepth® camera.

The embodiments disclosed herein implement low bitrate digital human communication sessions using motion capture data streams that present participants with high-resolution imagery of the other participants of the communication session without the need to stream video over a network. As an example, in some embodiments a first computing device engaged in a communication session receives, from a second computing device engaged in the communication session, a motion capture data stream that quantifies real-time movements of a user of the second computing device. The first computing device renders imagery of the user of the second computing device based on a 3D model of the user and on the motion capture data stream to generate a rendered image stream of the user that depicts the real-time movements of the user. The first computing device presents, on a display device during the communication session, the rendered image stream.

The embodiments implement high resolution 3D imagery of a participant of a conference along with hyper-realistic movements of the participant, including macro and micro facial expressions, without the need to stream imagery over the network, thereby vastly reducing network bandwidth consumption and allowing visual conferencing over low-bandwidth communication links. The reduced network bandwidth facilitates higher-quality audio streams and reduces or eliminates audio degradation problems.

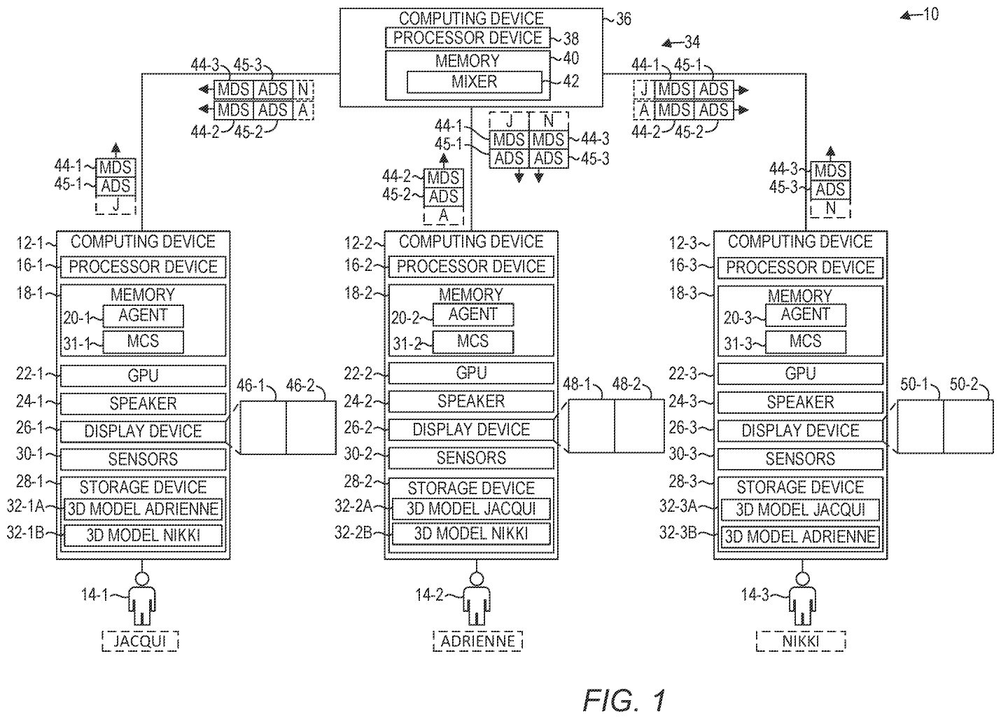

FIG. 1 is a block diagram of an environment 10 in which low bitrate digital human communication sessions using motion capture data streams can be implemented according to some embodiments. The environment 10 includes a plurality of computing devices 12-1-12-3 (generally, computing devices 12), each of which is operated by a corresponding user 14-1-14-3 (generally, users 14, sometimes referred to as participants). The computing devices 12 each have a corresponding processor device 16-1-16-3 and a memory 18-1-18-3 (generally, memories 18). Agents 20-1-20-3 may execute in the memories 18 to implement much or all of the functionality described herein. The computing devices 12 may comprise, for example, a smartphone, a computing tablet, a laptop or desktop computer, a smart television, or the like.

The computing devices 12 may include graphics processing units (GPUs) 22-1-22-3 suitable for rendering high-resolution imagery. The computing devices 12 include or are coupled to various components, such as audio devices, such as speakers 24-1-24-3, display devices 26-1-26-3 and storage devices 28-1-28-3. The computing devices 12 include or are coupled to one or more sensors 30-1-30-3 (generally, sensors 3). The sensors 30 comprise, for example, motion capture and/or depth sensors capable of mathematically measuring human features in 3D space. Such sensors may comprise, by way of non-limiting example, time of flight (ToF) sensors, or a depth camera, such as, by way of non-limiting example, an Apple® TrueDepth® camera.

The sensors 30 operate in conjunction with a motion capture software (MCC) 31-1-31-3 to generate motion capture (mocap) data that quantifies real-time movements of the corresponding user 14. Such movements can include, by way of non-limiting example, macro and micro facial expressions, head movements, body movements, hand movements, and the like. Any suitable motion capture software may be used, including, by way of non-limiting example, Rokoko motion capture software available at rokoko.com, After Effects motion capture software available at adobe.com, or the like.

The storage devices 28-1-28-3 store 3D models of users 14 with whom the corresponding users 14-1-14-3 may engage in a communication session. In this example, the storage device 28-1 contains a 3D model 32-1A of the user 14-2 and a 3D model 32-1B of the user 14-3, the storage device 28-2 contains a 3D model 32-2A of the user 14-1 and a 3D model 32-2B of the user 14-3, and the storage device 28-3 contains a 3D model 32-3A of the user 14-1 and a 3D model 32-3B of the user 14-2. The 3D models may be referred to generally as the 3D models 32. The 3D models 32 may be generated by any suitable 3D modeling software, such as, by way of non-limiting example, Maya 3D modeling software available at Autodesk.com, Facial Studio modeling software available at di-o-matic.com, or the like. The 3D models 32 may be generated in part based on high-resolution images, such as 4k resolution images of the corresponding users 14 and when rendered, depict the users 14 substantially identically to a real-time video stream of the users 14.

The computing devices 12 may communicate with one another over one or more networks 34. In some embodiments the 3D models 32 may be stored on the storage devices 28 prior to the initiation of a communication session. In some embodiments the 3D models 32 may be exchanged by the computing devices 12 over the networks 34 at the initiation of a communication session based on who is participating in the communication session.

In this embodiment the environment 10 includes a centralized computing device 36, such as a cloud computing device or the like, that facilitates digital human communication sessions. The term “digital human” as used herein refers to a 3D model of an individual who is participating in a communication session. The computing device 36 may include a processor device 38 and a memory 40. A mixer 42 operates to distribute information sent by each computing device 12 during a communication session to the other computing devices 12 participating in the communication session.

An example of a low bitrate digital human communication session using motion capture data streams will be described herein. Assume in this example that the user 14-1 scheduled a communication session between the users 14-1-14-3 to occur at a predetermined time by sending the users 14-2 and 14-3 an electronic invite that included a selectable link, similar to conventional collaboration mechanisms. At the predetermined time, each of the users 14 select the selectable link, which causes the agents 20-1-20-3 to establish connections with the mixer 42 and causes the establishment of a communication session between the computing devices 12-1-12-3.

The agent 20-1 interacts with the motion capture software 31-1 to obtain motion capture data (hereinafter, mocap data) that quantifies movements of the user 14-1, such as facial movements, head movements, hand movements, and the like. While the motion capture software 31-1 is illustrated as a separate component from the agent 20-1, in other implementations the motion capture software 31-1 may be integral with the agent 20-1. The motion capture software 31-1 generates the mocap data based on information received from the sensors 30-1. During the communication session the agent 20-1 continuously sends (e.g., streams) the mocap data as a mocap data stream 44-1 toward the computing devices 12-2 and 12-3 by sending the mocap data stream 44-1 to the mixer 42 for distribution to the computing devices 12-2 and 12-3. The agent 20-1 does not send a video stream of the user 14-1. The agent 20-1 may also receive audio information of the user 14-1 via a sensor 30, such as a microphone. The agent 20-1 may continuously send an audio stream 45-1 of the audio information toward the computing devices 12-2 and 12-3. In some embodiments, the audio may be spatial audio.

Concurrently, the agent 20-2 interacts with the motion capture software 31-2 to obtain mocap data of the user 14-2. The agent 20-2 continuously sends the mocap data as a mocap data stream 44-2 toward the computing devices 12-1 and 12-3 by sending the mocap data stream 44-2 to the mixer 42 for distribution to the computing devices 12-1 and 12-3. The agent 20-2 does not send a video stream of the user 14-2. The agent 20-2 may also receive audio information of the user 14-2 via a sensor 30, such as a microphone. The agent 20-2 may continuously send an audio stream 45-2 of the audio information toward the computing devices 12-1 and 12-3.

Concurrently, the agent 20-3 interacts with the motion capture software 31-3 to obtain mocap data of the user 14-3. The agent 20-3 continuously sends the mocap data as a mocap data stream 44-3 toward the computing devices 12-1 and 12-2 by sending the mocap data stream 44-3 to the mixer 42 for distribution to the computing devices 12-1 and 12-2. The agent 20-3 does not send a video stream of the user 14-3. The agent 20-3 may also receive audio information of the user 14-3 via a sensor 30, such as a microphone. The agent 20-3 may continuously send an audio stream 45-3 of the audio information toward the computing devices 12-1 and 12-2.

The mixer 42 operates to receive the mocap data streams 44 and audio streams 45, and provides the streams to the computing devices 12 that did not originate the respective streams. In particular, the mixer 42 continuously sends the mocap data stream 44-1 and audio stream 45-1 to the computing devices 12-2 and 12-3, the mocap data stream 44-2 and audio stream 45-2 to the computing devices 12-1 and 12-3, and the mocap data stream 44-3 and audio stream 45-3 to the computing devices 12-1 and 12-2. It should be noted that the mixer 42 may halt streaming audio information to a computing device 12 if the corresponding user 14 of the computing device 12 is the active speaker, as may occur during conventional audio calls.

The agent 20-1 receives the mocap data stream 44-2 and the audio stream 45-2 originating from the computing device 14-2. The agent 20-1 may not receive video imagery from the computing device 14-2 during the communication session. The agent 20-1 may present the audio stream 45-2 of the user 14-2 on the speaker 24-1. The mocap data stream 44-2 may include identification information, such as, by way of non-limiting example, a user identifier, that the agent 20-1 can use to correlate the 3D model 32-1A with the user 14-2. The agent 20-1 may determine, based on the user identifier, that the 3D model 32-1A corresponds to the user 14-2. The agent 20-1 loads the 3D model 32-1A into the memory 18-1.

The agent 20-1 animates the 3D model 32-1A of the user 14-2 based on the mocap data stream 44-2 and renders imagery of the animation to generate a rendered image stream 46-1 that depicts the real-time movements of the user 14-2. The agent 20-1 renders the rendered image stream 46-1 to the display device 26-1 concurrently with the presentation of the audio stream 45-2 on the speaker 24-1. The rendered image stream 46-1 may be a high-resolution image stream, such as a 4K image stream.

The real-time movements of the user 14-2 may comprise, by way of non-limiting example, macro or micro facial expressions, other facial movements, lip movements while speaking and when not speaking, eye movements, head movements, body movements, hand movements, and the like. The agent 20-1 may animate the 3D model 32-1A and generate the rendered image stream 46-1 using any suitable 3D model animation technology, such as, by way of non-limiting example, Maya 3D model animation technology available at Autodesk.co.uk.

Concurrently with processing the mocap data stream 44-2 as described above, the agent 20-1 receives the mocap data stream 44-3 and the audio stream 44-3 originating from the computing device 14-3. The agent 20-1 may not receive video imagery from the computing device 14-3 during the communication session. The agent 20-1 may present on the speaker 24-1 the audio stream of the user 14-3. The mocap data stream 44-3 may include a user identifier of the user 14-3. The agent 20-1 may determine, based on the user identifier, that the 3D model 32-1B corresponds to the user 14-3. The agent 20-1 loads the 3D model 32-1B into the memory 18-1.

The agent 20-1 animates the 3D model 32-1B of the user 14-3 based on the mocap data stream 44-3 and renders imagery of the animation to generate a rendered image stream 46-2 that depicts the real-time movements of the user 14-3. The agent 20-1 presents the rendered image stream 46-2 on the display device 26-1 concurrently with the presentation of the rendered image stream 46-1. Again, the real-time movements of the user 14-3 may comprise, by way of non-limiting example, macro or micro facial expressions, lip and eye movements, other facial movements, head movements, body movements, hand movements, and the like.

The agent 20-2 performs similar processing on the mocap data streams 44-1 and 44-3 to generate a rendered image stream 48-1 that depicts the real-time movements of the user 14-1 and a rendered image stream 48-2 that depicts the real-time movements of the user 14-3. The agent 20-2 presents the rendered image streams 48-1, 48-2 on the display device 26-2.

The agent 20-3 performs similar processing on the mocap data streams 44-1 and 44-2 to generate a rendered image stream 50-1 that depicts the real-time movements of the user 14-1 and a rendered image stream 50-2 that depicts the real-time movements of the user 14-2. The agent 20-3 presents the rendered image streams 50-1, 50-2 on the display device 26-3.

This process continues in real-time for the duration of the communication session. Because no video imagery is communicated over the network 34, the embodiments utilize relatively little network bandwidth, and hundreds of times less bandwidth than a conventional video conference call, permitting high-resolution visual imagery even over low bandwidth communication links. Despite the low bandwidth communication links, each user 14 views a hyper-realistic animation of the users 14 that depicts the imagery of the users 14 and real-time actual movements of the users 14.

In some embodiments, the computing devices 12-1-12-3 include light field data generators operable to render a light field image stream based on the respective 3D models and the mocap data streams 44. The display devices 26-1-26-3 are light field display devices and provide light field display output to the users 14 in response to receiving the light field image stream. In another embodiment, the computing devices 12-1-12-3 include holographic data renderers operable to render a holographic display image stream based on the respective 3D models and the mocap data streams 44. The display devices 26-1-26-3 are holographic display devices and provide holographic display output to the users 14 in response to receiving the holographic display image stream. It is noted that communication of holographic data over a network requires substantial network bandwidth that is not required by the present embodiments.

It is noted that, because the agent 20-1 is a component of the computing device 12-1, functionality implemented by the agent 20-1 may be attributed to the computing device 12-1 generally. Moreover, in examples where the agent 20-1 comprises software instructions that program the processor device 16-1 to carry out functionality discussed herein, functionality implemented by the agent 20-1 maybe attributed herein to the processor device 16-1.

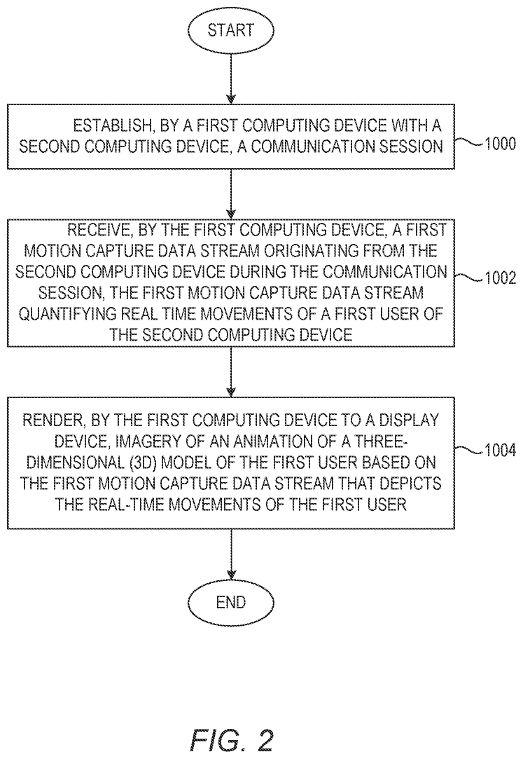

FIG. 2 is a flowchart of a method for implementing a low bitrate digital human communication sessions using motion capture data streams according to one embodiment. FIG. 2 will be discussed in conjunction with FIG. 1. The computing device 12-1 establishes, with the computing device 12-2, a communication session (FIG. 2, block 1000). The computing device 12-1 receives the motion capture data stream 44-2 originating from the computing device 12-2 during the communication session, the motion capture data stream 44-2 quantifying real-time movements of the user 14-2 of the computing device 12-2 (FIG. 2, block 1002). The computing device 12-1 renders, to the display device 26-1, imagery of an animation of the three-dimensional (3D) model 32-1A of the user 14-2 based on the first motion capture data stream 44-2 that depicts the real-time movements of the user 14-2.

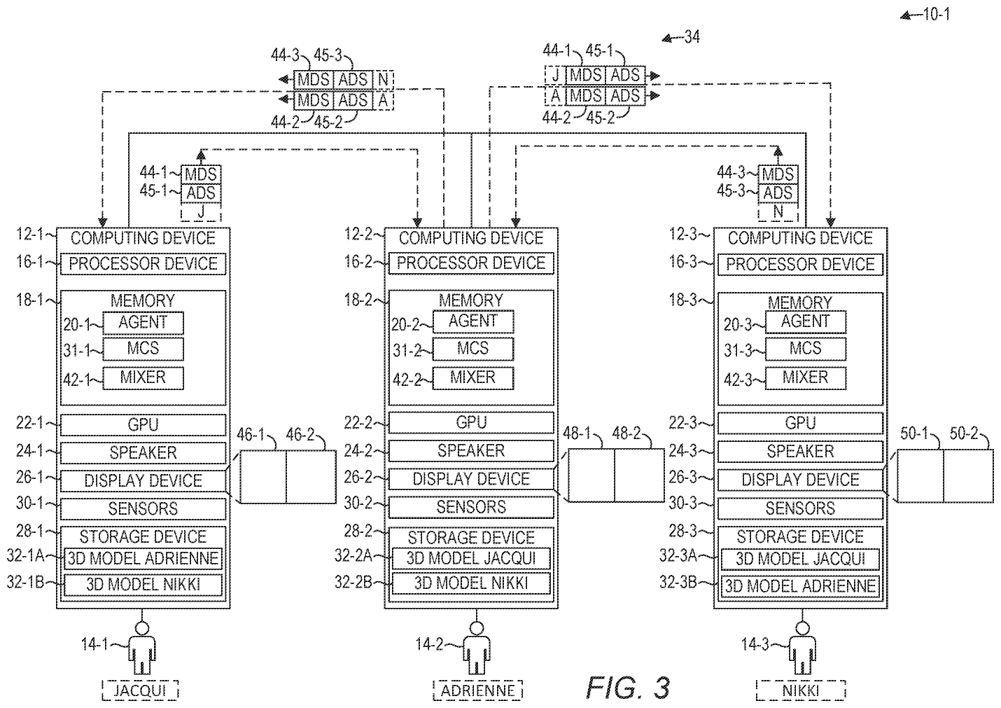

FIG. 3 is a block diagram of an environment 10-1 in which low bitrate digital human communication sessions using motion capture data streams can be implemented according to another embodiment. The environment 10-1 is substantially similar to the environment 10 except as otherwise discussed herein. In this embodiment, one or more of the computing devices 12-1-12-3 may include a mixer 42-1-42-3 that operates substantially similarly to the mixer 42 discussed above with regards to FIG. 1. As an example of a low bitrate digital human communication session using motion capture data streams in accordance with the embodiment of FIG. 3, assume that the user 14-2 has initiated a call with the user 14-1 by, for example, dialing a telephone number or selecting a person associated with a corresponding destination address on the computing device 12-1. After the user 14-1 accepts the call, the user 14-2 may then place the user 14-1 on hold and initiate a call with the user 14-3 by, for example, dialing a telephone number or other destination address associated with the computing device 12-3. After the user 14-3 accepts the call, the user 12-1 may merge the calls such that a communication session now exists between the computing devices 12-1-12-3.

The computing device 12-1 sends the mocap data stream 44-1 and the audio stream 45-1, as described above with regard to FIG. 1, to the computing device 12-2. The computing device 12-3 sends the mocap data stream 44-3 and the audio stream 45-3, as described above with regard to FIG. 1, to the computing device 12-2. The computing device 12-2 generates the mocap data stream 44-2 and the audio stream 45-2, as described above with regard to FIG. 1. The mixer 42-2 continuously sends the mocap data stream 44-2 and audio stream 45-2 to the computing devices 12-1 and 12-3, the mocap data stream 44-1 and audio stream 45-1 to the computing device 12-3, and the mocap data stream 44-3 and audio stream 45-3 to the computing device 12-1. As discussed above, it should be noted that the mixer 42-2 may halt streaming audio information to a computing device 12 if the corresponding user 14 is the active speaker, as may occur during conventional audio calls. The computing devices 12 then render imagery of the users 14 to display devices using the corresponding 3D models 32 and mocap data streams 44 substantially as discussed above with regard to FIG. 1.

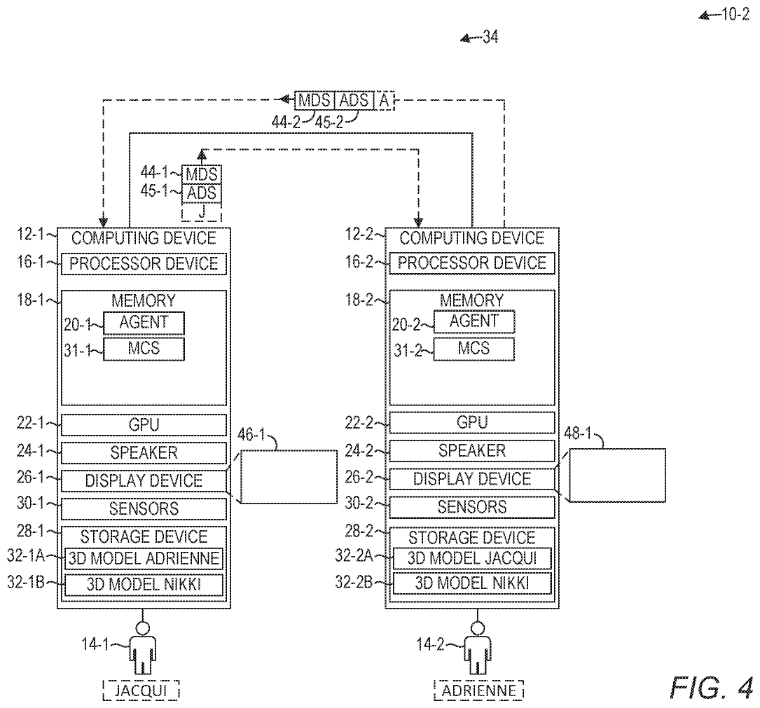

FIG. 4 is a block diagram of an environment 10-2 in which low bitrate digital human communication sessions using motion capture data streams can be implemented according to another embodiment. The environment 10-2 is substantially similar to the environment 10 except as otherwise discussed herein. In this embodiment, a communication session is generated between the two computing devices 12-1 and 12-2 and no mixer 42 may be required. As an example of a low bitrate digital human communication session using motion capture data streams in accordance with the embodiment of FIG. 4, assume that the user 14-2 has initiated a call with the user 14-1 by, for example, dialing a telephone number or other destination address associated with the computing device 12-1. The user 14-1 answers the call, thereby establishing a communication session between the computing devices 12-1 and 12-2.

The computing device 12-1 sends the mocap data stream 44-1 and the audio stream 45-1, as described above with regard to FIG. 1, to the computing device 12-2. The computing device 12-2 sends the mocap data stream 44-2 and the audio stream 45-2, as described above with regard to FIG. 1, to the computing device 12-1. The computing devices 12 then render and present imagery of the users 14 using the corresponding 3D models 32 and mocap data streams 44 substantially as discussed above with regard to FIG. 1.

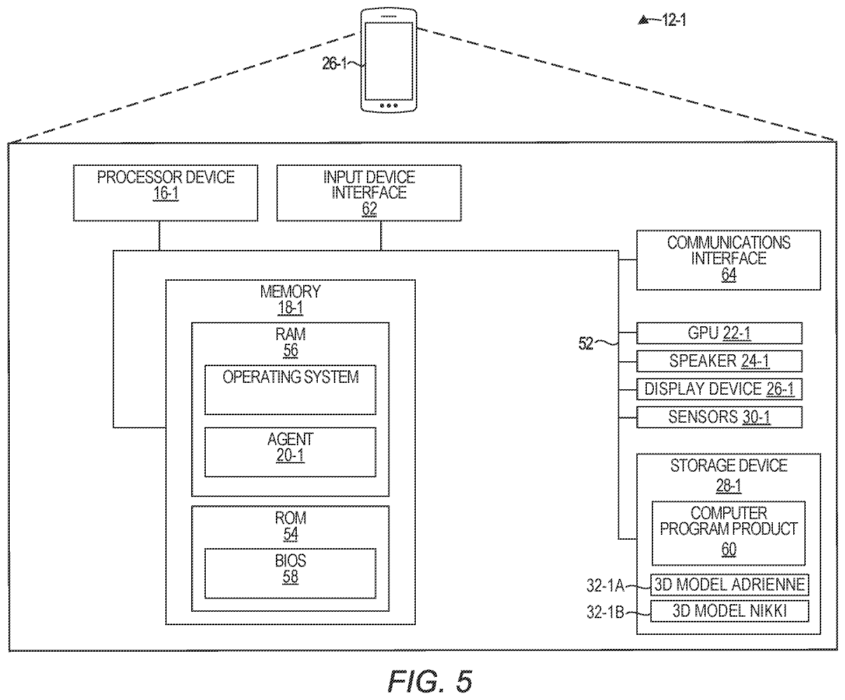

FIG. 5 is a block diagram of the computing device 12-1 suitable for implementing examples according to one example. The computing device 12-1 may comprise any computing or electronic device or combination thereof capable of including or being coupled to firmware, hardware, and/or executing software instructions to implement the functionality described herein, such as a smartphone, a computing tablet, a laptop or desktop computer, a smart television, an augmented reality headset, a mixed reality headset, a virtual reality headset, or the like. The computing device 12-1 includes the processor device 16-1, the system memory 18-1, and a system bus 52. The system bus 52 provides an interface for system components including, but not limited to, the system memory 18-1 and the processor device 16-1. The processor device 16-1 can be any commercially available or proprietary processor.

The system bus 52 may be any of several types of bus structures that may further interconnect to a memory bus (with or without a memory controller), a peripheral bus, and/or a local bus using any of a variety of commercially available bus architectures. The system memory 18-1 may include non-volatile memory 54 (e.g., read-only memory (ROM), erasable programmable read-only memory (EPROM), electrically erasable programmable read-only memory (EEPROM), etc.), and volatile memory 56 (e.g., random-access memory (RAM)). A basic input/output system (BIOS) 58 may be stored in the non-volatile memory 54 and can include the basic routines that help to transfer information between elements within the computing device 12-1. The volatile memory 56 may also include a high-speed RAM, such as static RAM, for caching data.

The computing device 12-1 may further include or be coupled to a non-transitory computer-readable storage medium such as the storage device 28-1, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 28-1 and other drives associated with computer-readable media and computer-usable media may provide non-volatile storage of data, data structures, computer-executable instructions, and the like.

A number of modules can be stored in the storage device 28-1 and in the volatile memory 56, including an operating system and one or more program modules, such as the agent 20-1, which may implement the functionality described herein in whole or in part. All or a portion of the examples may be implemented as a computer program product 60 stored on a transitory or non-transitory computer-usable or computer-readable storage medium, such as the storage device 28-1, which includes complex programming instructions, such as complex computer-readable program code, to cause the processor device 16-1 to carry out the steps described herein. Thus, the computer-readable program code can comprise software instructions for implementing the functionality of the examples described herein when executed on the processor device 16-1. The processor device 16-1, in conjunction with the agent 20-1 in the volatile memory 56, may serve as a controller, or control system, for the computing device 12-1 that is to implement the functionality described herein.

An operator, such as the user 14-1, may also be able to enter one or more configuration commands through a keyboard (not illustrated), a pointing device such as a mouse (not illustrated), or a touch-sensitive surface such as the display device 26-1. Such input devices may be connected to the processor device 16-1 through an input device interface 62 that is coupled to the system bus 52 but can be connected by other interfaces such as a parallel port, an Institute of Electrical and Electronic Engineers (IEEE) 1394 serial port, a Universal Serial Bus (USB) port, an IR interface, and the like. The computing device 12-1 may also include a communications interface 64 suitable for communicating with the network 34 as appropriate or desired.

Individuals will recognize improvements and modifications to the preferred examples of the disclosure. All such improvements and modifications are considered within the scope of the concepts disclosed herein and the claims that follow.

What is claimed is:

1. A method comprising:
establishing, by a first computing device with a second computing device, a communication session;
receiving, by the first computing device, a first motion capture data stream originating from the second computing device during the communication session, the first motion capture data stream quantifying real-time movements of a first user of the second computing device; and
rendering, by the first computing device to a display device, imagery of an animation of a three-dimensional (3D) model of the first user based on the first motion capture data stream that depicts the real-time movements of the first user.

2. The method of claim 1 further comprising:
receiving, by the first computing device from the second computing device during the communication session, an audio stream; and
presenting, on an audio device, the audio stream while concurrently rendering, to the display device, the imagery of the animation of the 3D model of the first user based on the first motion capture data stream that depicts the real-time movements of the first user.

3. The method of claim 1 wherein the first computing device does not receive a video stream from the second computing device during the communication session.

4. The method of claim 1 further comprising:
generating, by the first computing device during the communication session, a second motion capture data stream that quantifies real-time movements of a second user of the first computing device; and
sending, by the first computing device, the second motion capture data stream toward the second computing device.

5. The method of claim 1 further comprising:
determining, by the first computing device, a first user identifier that identifies the first user;
based on the first user identifier, selecting, by the first computing device, the 3D model of the first user from a plurality of 3D models; and
loading, by the first computing device, the 3D model into a memory of the first computing device.

6. The method of claim 1 further comprising:
receiving, by the first computing device, a second motion capture data stream originating from a third computing device during the communication session, the second motion capture data stream quantifying real-time movements of a second user of the third computing device; and
wherein rendering, by the first computing device to the display device, the imagery of the animation of the 3D model of the first user based on the first motion capture data stream that depicts the real-time movements of the first user further comprises:
concurrently rendering, by the first computing device to the display device, imagery of the animation of the 3D model of the first user based on the first motion capture data stream that depicts the real-time movements of the first user and imagery of an animation of a 3D model of the second user based on the second motion capture data stream that depicts the real-time movements of the second user.

7. The method of claim 1 wherein the first motion capture data stream identifies one or more of facial movements of the first user and hand movements of the first user.

8. The method of claim 1 wherein establishing, by the first computing device with the second computing device, the communication session comprises connecting, by the first computing device, to a mixer that is operable to receive first audio communications from the first computing device and provide the first audio communications to the second computing device, and to receive second audio communications from the second computing device and provide second audio the communications to the first computing device.

9. The method of claim 1 wherein establishing, by the first computing device with the second computing device, the communication session comprises directly contacting, by the first computing device, the second computing device.

10. The method of claim 1 wherein the display device comprises a holographic display device and wherein rendering, by the first computing device to the display device, the imagery of the animation of the 3D model of the first user based on the first motion capture data stream that depicts the real-time movements of the first user comprises:
rendering, by the first computing device to the holographic display device, the imagery of the animation of the 3D model of the first user based on the first motion capture data stream that depicts the real-time movements of the first user.

11. The method of claim 1 wherein the display device comprises a light field display device and wherein rendering, by the first computing device to the display device, the imagery of the animation of the 3D model of the first user based on the first motion capture data stream that depicts the real-time movements of the first user comprises:
rendering, by the first computing device to the light field display device, the imagery of the animation of the 3D model of the first user based on the first motion capture data stream that depicts the real-time movements of the first user.

12. A first computing device, comprising:
a memory; and
a processor device coupled to the memory operable to:
establish, with a second computing device, a communication session;
receive a first motion capture data stream originating from the second computing device during the communication session, the first motion capture data stream quantifying real-time movements of a first user of the second computing device; and
render, to a display device, imagery of an animation of a three-dimensional (3D) model of the first user based on the first motion capture data stream that depicts the real-time movements of the first user.

13. The first computing device of claim 12 wherein the processor device is further operable to:
receive, from the second computing device during the communication session, an audio stream; and
present, on an audio device, the audio stream while concurrently rendering, to the display device, the imagery of the animation of the 3D model of the first user based on the first motion capture data stream that depicts the real-time movements of the first user.

14. The first computing device of claim 12 wherein the processor device is further operable to:
generate, during the communication session, a second motion capture data stream that quantifies real-time movements of a second user of the first computing device; and
send the second motion capture data stream toward the second computing device.

15. The first computing device of claim 12 wherein the processor device is further operable to:
determine a first user identifier that identifies the first user;
based on the first user identifier, select the 3D model of the first user from a plurality of 3D models; and
load the 3D model into the memory of the first computing device.

16. The first computing device of claim 12 wherein the processor device is further operable to:
receive a second motion capture data stream originating from a third computing device during the communication session, the second motion capture data stream quantifying real-time movements of a second user of the third computing device;
and wherein to render, to the display device, the imagery of the animation of the 3D model of the first user based on the first motion capture data stream that depicts the real-time movements of the first user, the processor device is further to:
concurrently render, to the display device, the imagery of the animation of the 3D model of the first user based on the first motion capture data stream that depicts the real-time movements of the first user and imagery of an animation of a 3D model of the second user based on the second motion capture data stream that depicts the real-time movements of the second user.

17. A non-transitory computer-readable storage medium that includes executable instructions operable to cause a processor device of a first computing device to:
establish, with a second computing device, a communication session;
receive a first motion capture data stream originating from the second computing device during the communication session, the first motion capture data stream quantifying real-time movements of a first user of the second computing device; and
render, to a display device, imagery of an animation of a three-dimensional (3D) model of the first user based on the first motion capture data stream that depicts the real-time movements of the first user.

18. The non-transitory computer-readable storage medium of claim 17 wherein the instructions are further operable to cause the processor device to:
generate, during the communication session, a second motion capture data stream that quantifies real-time movements of a second user of the first computing device; and
send the second motion capture data stream toward the second computing device.

19. The non-transitory computer-readable storage medium of claim 17 wherein the instructions are further operable to cause the processor device to:
determine a first user identifier that identifies the first user;
based on the first user identifier, select the 3D model of the first user from a plurality of 3D models; and
load the 3D model into a memory of the first computing device.

20. The non-transitory computer-readable storage medium of claim 17 wherein the instructions are further operable to cause the processor device to:
receive a second motion capture data stream originating from a third computing device during the communication session, the second motion capture data stream quantifying real-time movements of a second user of the third computing device;
and wherein to render, by the first computing device to the display device, the imagery of the animation of the 3D model of the first user based on the first motion capture data stream that depicts the real-time movements of the first user, the processor device is further to:
concurrently render, by the first computing device to the display device, the imagery of the animation of the 3D model of the first user based on the first motion capture data stream that depicts the real-time movements of the first user and imagery of an animation of a 3D model of the second user based on the second motion capture data stream that depicts the real-time movements of the second user.
